(19) United States
(12) Patent Application Publication
(10) Pub. No.: US 2025/0105957 A1
(43) Pub. Date: Mar. 27, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Haruhi Echigo, Tokyo (JP); Satoshi Nagata, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/728,375

(22) PCT Filed: Jan. 14, 2022
(86) PCT No.: PCT/JP2022/001176

§ 371 Date: Jul. 11, 2024

(51) Int. Cl. H04L 5/00

(52) U.S. Cl. CPC H04L 5/0035; H04L 5/0053

(57) ABSTRACT

A terminal according to one aspect of the present disclosure includes: a receiving section that receives a first parameter for transmission to a first transmission/reception point (TRP) and a second parameter for transmission to a second TRP; and a control section that controls transmission of one transport block over N slots and applies N parameters to the N respective slots, the N parameters including at least one of the first parameter and the second parameter, N being an integer equal to or greater than two. According to one aspect of the present disclosure, it is possible to appropriately carry out transmission of data over a plurality of slots in a case where multi-TRP is configured/indicated.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V 8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is studied that one or a plurality of transmission/reception points (TRPs) (single TRP (STRP)/multi-TRP (Multi TRP (MTRP))) perform DL transmission to a terminal (user terminal, User Equipment (UE)). It is also studied that the UE performs UL transmission by using one or a plurality of panels to the one or plurality of TRPs.

It is also studied that a UE transmits a single data (for example, transport block) over a plurality of slots.

However, study about a method of data transmission over a plurality of slots in a case where multi-TRP is configured/indicated has not advanced. Unless such a method is clearly defined, communication throughput, communication quality, and the like may degrade.

In view of this, the present disclosure has one object to provide a terminal, a radio communication method, and a base station that can appropriately carry out transmission of data over a plurality of slots in a case where multi-TRP is configured/indicated.

### Solution to Problem

A terminal according to one aspect of the present disclosure includes: a receiving section that receives a first parameter for transmission to a first transmission/reception point (TRP) and a second parameter for transmission to a second TRP; and a control section that controls transmission of one transport block over N slots and applies N parameters to the N respective slots, the N parameters including at least one of the first parameter and the second parameter, N being an integer equal to or greater than two.

### Advantageous Effects of Invention

According to one aspect of the present disclosure, it is possible to appropriately carry out transmission of data over a plurality of slots in a case where multi-TRP is configured/indicated.

### BRIEF DESCRIPTION OF DRAWINGS

FIG. 1 illustrates an example of indication of switching between a single-TRP mode and a multi-TRP mode using DCI.

FIG. 2 illustrates an example of Rel-17 multi-TRP PUSCH repetition using repetition type A.

FIGS. 3A and 3B are diagrams to illustrate examples of PUSCH repetition type A with TBOMS.

FIG. 4 illustrates an example of option 1-1.

FIGS. 5A and 5B illustrate examples of cyclic mapping of option 1-2.

FIGS. 6A and 6B illustrate examples of sequential mapping of option 1-2.

FIGS. 7A and 7B illustrate examples of half-half mapping of option 1-2.

FIGS. 8A and 8B illustrate examples of option 2-2-1.

FIGS. 9A and 9B illustrate examples of option 2-2-2.

FIG. 10 illustrates another example of option 2-2-2.

FIGS. 11A and 11B illustrate examples of a difference between options 2-2-2 and 2-2-3.

FIG. 12 is a diagram to illustrate an example of a schematic structure of a radio communication system according to one embodiment.

FIG. 13 is a diagram to illustrate an example of a structure of a base station according to one embodiment.

FIG. 14 is a diagram to illustrate an example of a structure of a user terminal according to one embodiment.

FIG. 15 is a diagram to illustrate an example of a hardware structure of the base station and the user terminal according to one embodiment.

FIG. 16 is a diagram to illustrate an example of a vehicle according to one embodiment.

### DESCRIPTION OF EMBODIMENTS

### (Spatial Relation for SRS, PUSCH)

In Rel-15/16 NR, a UE may receive information to be used for transmission of a reference signal for measurement (for example, a sounding reference signal (SRS)) (SRS configuration information, for example, a parameter in an RRC control element “SRS-Config”).

Concretely, the UE may receive at least one of information related to one or a plurality of SRS resource sets (SRS resource set information, for example, an RRC control element “SRS-ResourceSet”) and information related to one or a plurality of SRS resources (SRS resource information, for example, an RRC control element “SRS-Resource”).

One SRS resource set may relate to a certain number of (for example, one or more or a plurality of) SRS resources (may group the certain number of SRS resources). Each of the SRS resources may be identified by an SRS resource indicator (SRI) or an SRS resource ID (Identifier).

The SRS resource set information may include information of an SRS resource set ID (SRS-ResourceSetId), a list of SRS resource IDs (SRS-ResourceId) used in the resource set, an SRS resource type (for example, any one of periodic SRS, semi-persistent SRS, and aperiodic CSI), and/or usage of the SRS.

Here, the SRS resource type may indicate any one of periodic SRS (P-SRS), semi-persistent SRS (SP-SRS), and aperiodic CSI (Aperiodic SRS (A-SRS)). Note that the UE may transmit a P-SRS and an SP-SRS periodically (or periodically after activation), and transmit an A-SRS, based on an SRS request of DCI.

The usage (RRC parameter “usage,” L1 (Layer-1) parameter “SRS-SetUse”) may be beam management (beamManagement), codebook (CB), non-codebook (noncodebook (NCB)), antenna switching, or the like, for example. An SRS with codebook (CB) or non-codebook (NCB) usage may be used for determination of a precoder for codebook based or non-codebook based PUSCH transmission based on an SRI.

For example, in a case of codebook based transmission, the UE may determine a precoder for PUSCH transmission, based on the SRI, a transmitted rank indicator (TRI), and a transmitted precoding matrix indicator (TPMI). In a case of non-codebook based transmission, the UE may determine a precoder for PUSCH transmission, based on the SRI.

The SRS resource information may include an SRS resource ID (SRS-ResourceId), the number of SRS ports, SRS port numbers, transmission Comb, SRS resource mapping (for example, time and/or frequency resource location, resource offset, resource periodicity, the number of repetitions, the number of SRS symbols, SRS bandwidth, and the like), hopping related information, an SRS resource type, a sequence ID, spatial relation information of the SRS, and the like.

The spatial relation information of the SRS (for example, an RRC information element “spatialRelationinfo”) may indicate spatial relation information between a certain reference signal and the SRS. The certain reference signal may be at least one of a synchronization signal/broadcast channel (Synchronization Signal/Physical Broadcast Channel (SS/PBCH)) block, a channel state information reference signal (CSI-RS), and an SRS (for example, another SRS). The SS/PBCH block may be referred to as a synchronization signal block (SSB).

The spatial relation information of the SRS may include at least one of an SSB index, a CSI-RS resource ID, and an SRS resource ID as the index of the certain reference signal.

Note that, in the present disclosure, an SSB index, an SSB resource ID, and an SSB Resource Indicator (SSBRI) may be interchangeably interpreted. A CSI-RS index, a CSI-RS resource ID, and a CSI-RS Resource Indicator (CRI) may be interchangeably interpreted. An SRS index, an SRS resource ID, and an SRI may be interchangeably interpreted.

The spatial relation information of the SRS may include a serving cell index, a BWP index (BWP ID), or the like corresponding to the above certain reference signal.

When the UE is configured with spatial relation information related to an SSB or a CSI-RS and an SRS for a certain SRS resource, the UE may transmit the SRS resource by using the same spatial domain filter (spatial domain transmission filter) as a spatial domain filter (spatial domain reception filter) for receiving the SSB or the CSI-RS. In this case, the UE may assume that a UE receive beam of the SSB or the CSI-RS and a UE transmit beam of the SRS are the same.

When the UE is configured, for the resource of a certain SRS (target SRS), with spatial relation information related to another SRS (reference SRS) and the certain SRS (target SRS), the UE may transmit the target SRS resource by using the same spatial domain filter (spatial domain transmission filter) as a spatial domain filter (spatial domain transmission filter) for transmitting the reference SRS. In other words, in this case, the UE may assume that a UE transmit beam of the reference SRS and a UE transmit beam of the target SRS are the same.

The UE may determine a spatial relation of a PUSCH scheduled by DCI (for example, DCI format 0_1), based on a value of a certain field (for example, an SRS resource indicator (SRI) field) in the DCI. Specifically, the UE may use the spatial relation information (for example, an RRC information element “spatialRelationInfo”) of an SRS resource determined based on the value of the certain field (for example, SRI), for PUSCH transmission.

In Rel-16 NR, when codebook based PUSCH transmission is used, a UE may be configured with one SRS resource set with usage=CB, configured with two SRS resources for the SRS resource set by RRC, and indicated with one of the two SRS resources by DCI (for example, 1-bit SRI field). Note that, except for a case where full-power mode 2 is configured (for example, a higher layer parameter ul-FullPowerTransmission-r16 is configured at fullpowerMode2), the SRS resources of the same SRS resource set may have the same number of ports (number of SRS ports).

In Rel-16 NR, when non-codebook based PUSCH transmission is used, a UE may be configured with one SRS resource set with usage=NCB, configured with four SRS resources per this SRS resource set by RRC, and indicated with one or a combination of the four SRS resources by DCI (for example, 2-bit SRI field). Note that each of the SRS resources of the SRS resource set with usage=NCB may have one port.

### (PUSCH Transmission Power Control)

In NR, the transmission power of a PUSCH is controlled based on a TPC command (also referred to as a value, an increase/decrease value, a correction value, or the like) indicated by the value of a field (also referred to as a TPC command field or the like) in DCI.

For example, when the UE transmits a PUSCH on an active UL BWP b of a carrier f in a serving cell c by using a parameter set (open loop parameter set) having an index j and an index l of a power control adjustment state (PUSCH power control adjustment state), the transmission power of the PUSCH (P_{PUSCH,b,f,c}(i, j, q_{d}, l)) [dBm] in PUSCH transmission occasion (also referred to as a transmission period or the like) i may be based on at least one of P_{CMAX,f,c}(i), P_{O_PUSCH,b,f,c}(j), M^{PUSCH}_{RB,b,f,c}(i), α_{b,f,c}(j), PL_{b,f,c}(q_{d}), Δ_{TF,b,f,c}(i), and f_{b,f,c}(i,l).

The power control adjustment state may be referred to as a closed loop (Cl)-power control (PC) state, a value based on a TPC command of a power control adjustment state index l, a TPC command accumulation value, and a value by closed loop. l may be referred to as a closed loop index.

The PUSCH transmission occasion i is a period in which a PUSCH is transmitted and may be constituted of one or more symbols, one or more slots, or the like, for example.

P_{CMAX,f,c}(i) denotes a transmission power (also referred to as a maximum transmission power, UE maximum output power, and the like) of a user terminal configured for the carrier fin the serving cell c in the transmission occasion i, for example.

P_{O_PUSCH,b,f,c}(j) denotes, for example, a parameter according to a target received power (also referred to as a parameter related to a transmission power offset, a transmission power offset P0, a target received power parameter, and the like, for example) configured for the active UL BWP b of the carrier f in the serving cell c in the transmission occasion i. P_{O_UE_PUSCH,b,f,c}(j) may denote the total of P_{O_NOMINAL_PUSCH,f,c}(j) and P_{O_UE_PUSCH,b,f,c}(j).

M^{PUSCH}_{RB,b,f,c}(i) denotes the number of resource blocks (bandwidth) allocated to a PUSCH for the transmission occasion i in the active UL BWP b of the carrier f in the serving cell c and the subcarrier spacing μ, for example. α_{b,f,c}( ) denotes a value provided by a higher layer parameter (for example, also referred to as msg3-Alpha, p0-PUSCH-Alpha, a fractional factor, and the like).

PL_{b,f,c}(q) denotes pathloss (pathloss estimation [dB], pathloss compensation) calculated by a user terminal by using an index q_{d} of a reference signal (reference signal (RS), pathloss reference RS, pathloss (PL)-RS, RS for pathloss reference, DL-RS for pathloss measurement, PUSCH-PathlossReferenceRS) for downlink BWP associated with the active UL BWP b of the carrier f in the serving cell c, for example.

When the UE is not provided with any pathloss reference RS (for example, PUSCH-pathlossReferenceRS) or when the UE is not provided with a dedicated higher layer parameter, the UE may calculate PL_{b,f,c}(q_{d}) by using an RS resource from a synchronization signal (SS)/physical broadcast channel (PBCH) block (SS block (SSB)) used for obtaining a Master Information Block (MIB).

When the UE is configured with RS resource indices the number of which is up to the value of the maximum number of pathloss reference RSs (for example, maxNrofPUSCH-PathlossReferenceRSs) and a set of RS configurations corresponding to the respective RS resource indices by pathloss reference RSs, the set of RS resource indices may include one of or both a set of SS/PBCH block indices and a set of channel state information (CSI)-reference signal (RS) resource indices. The UE may identify the RS resource index q_{d} in the set of RS resource indices.

When PUSCH transmission is scheduled by a Random Access Response (RAR) UL grant, the UE may use the same RS resource index q_{d} as that for corresponding PRACH transmission.

When the UE is provided with a configuration of power control for a PUSCH (for example, SRI-PUSCH-PowerControl) by a sounding reference signal (SRS) resource indicator (SRI) and also provided with one or more values of the ID(s) of a pathloss reference RS(s), the UE may obtain mapping between a set of values for an SRI field in DCI format 0_1 and a set of the ID values of the pathloss reference RSs from higher layer signaling (for example, sri-PUSCH-PowerControl-Id in SRI-PUSCH-PowerControl). The UE may determine an RS resource index q_{d} from the ID of the pathloss reference RS mapped to the SRI field value in DCI format 0_1 for scheduling the PUSCH.

When PUSCH transmission is scheduled by DCI format 0_0 and also the UE is not provided with PUCCH spatial relation information for a PUCCH resource having the lowest index for the active UL BWP b of each carrier f and the serving cell c, the UE may use the same RS resource index q_{d} as that of PUCCH transmission in the PUCCH resource.

When the PUSCH transmission is scheduled by DCI format 0_0 and the UE is not provided with spatial setting of PUCCH transmission, when the PUSCH transmission is scheduled by DCI format 0_1 not including an SRI field, or when the UE is not provided with the configuration of power control for the PUSCH by the SRI, the UE may use the RS resource index q_{d} with the ID of a zero pathloss reference RS.

When a configured grant configuration (for example, ConfiguredGrantConfig) includes a specific parameter (for example, rrc-ConfiguredUplinkGrant) for PUSCH transmission configured by the configured grant configuration, the RS resource index q_{d} may be provided to the UE by a pathloss reference index (for example, pathlossReferenceIndex) in the specific parameter.

When the configured grant configuration does not include the specific parameter for the PUSCH transmission configured by the configured grant configuration, the UE may determine the RS resource index q_{d} from the value of the ID of the pathloss reference RS mapped to the SRI field value in the DCI format for activating the PUSCH transmission. When the DCI format does not include any SRI field, the UE may determine the RS resource index q_{d} having the ID of the zero pathloss reference RS.

Δ_{TF,b,f,c}(i) denotes a transmission power adjustment component (offset, transmission format compensation) for the UL BWP b of the carrier f in the serving cell c.

f_{b,f,c}(i,l) denotes a PUSCH power control adjustment state for the active UL BWP b of the carrier f in the serving cell c in the transmission occasion i. f_{b,f,c}(i,l) may be based on δ_{PUSCH,b,f,c}(i,l).

When TPC accumulation is enabled, f_{b,f,c}(i,l) may be based on the accumulation value of δ_{PUSCH,b,f,c}(m,l).

When TPC accumulation is disabled, f_{b,f,c}(i,l) may be δ_{PUSCH,b,f,c}(i,l) (absolute value).

When information indicating the TPC accumulation (TPC-Accumulation) being disabled is not configured (when information indicating the TPC accumulation being disabled is not provided, when the TPC accumulation is configured at enabled), the UE accumulates TPC command values and determines transmission power, based on the result of the accumulation (power control state) (applies the TPC command values via the accumulation).

When the information indicating the TPC accumulation (TPC-Accumulation) being disabled is configured (when the information indicating the TPC accumulation being disabled is provided, when the TPC accumulation is configured at disabled), the UE does not accumulate TPC command values but determines transmission power, based on the TPC command values (power control state) (applies the TPC command values without using accumulation).

δ_{PUSCH,b,f,c}(i,l) may denote a TPC command value included in DCI format 0_0 or DCI format 0_1 for scheduling the PUSCH transmission occasion i in the active UL BWP b of the carrier f in the serving cell c or a TPC command value coded by being combined with another TPC command in DCI format 2_2 with a CRC scrambled with a specific RNTI (Radio Network Temporary Identifier) (for example, TPC-PUSCH-RNTI).

Σₘ₌₀^{C(Di)-1}δ_{PUSCH,b,f,c}(m,l) may denote the total of TPC command values in a set Dᵢ of the TPC command values with cardinality C(Dᵢ). Dᵢ may denote a set of TPC command values received by the UE between (K_{PUSCH}(i−i₀)−1) symbols before a PUSCH transmission occasion i−i₀ and K_{PUSCH}(i) symbols before the PUSCH transmission occasion i in the active UL BWP b of the carrier f in the serving cell c for the PUSCH power control adjustment state l. i₀ may be the smallest positive integer that enables (K_{PUSCH}(i−i₀) symbols before the PUSCH transmission occasion i−i₀ to be earlier than K_{PUSCH}(i) symbols before the PUSCH transmission occasion i.

If the PUSCH transmission is scheduled by DCI format 0_0 or DCI format 0_1, K_{PUSCH}(i) may denote the number of symbols in the active UL BWP b of the carrier f in the serving cell c after the last symbol of corresponding PDCCH reception and also before the first symbol of the PUSCH transmission. If the PUSCH transmission is configured by configured grant configuration information (ConfiguredGrantConfig), K_{PUSCH}(i) may denote the number of K_{PUSCH}, min symbols equal to the product of the number N_{symb}^{slot} of symbols per slot in the active UL BWP b of the carrier fin the serving cell c and the smallest value of values provided by k2 in PUSCH-common configuration information (PUSCH-ConfigCommon).

Whether the power control adjustment state includes a plurality of states (for example, two states) or include a single state may be configured by a higher layer parameter. When a plurality of power control adjustment states are configured, one of the plurality of power control adjustment states may be identified by the index l (for example, l∈{0, 1}).

### (Multi-TRP PUSCH Repetition)

In NR, it is studied that one or a plurality of transmission/reception points (TRPs) (multi-TRP (M-TRP)) perform DL transmission to a UE by using one or a plurality of panels (multi-panel). It is also studied that the UE performs UL transmission by using the one or plurality of panels to the one or plurality of TRPs.

It is studied to indicate, in future radio systems (for example, NR in Rel. 17 or later versions), a plurality of (for example, two) SRS resource indicators (SRIs)/transmitted precoding matrix indicators (TPMIs) by using single DCI for performing PUSCH repetition transmission by a plurality of TRPs (MTRP PUSCH repetition).

For example, in a case of codebook based transmission, a UE may determine a precoder for PUSCH transmission, based on an SRI, a transmitted rank indicator (TRI), and a TPMI. In a case of non-codebook based transmission, the UE may determine a precoder for PUSCH transmission, based on the SRI. Note that the SRI may be indicated for the UE by DCI or may be given by a higher layer parameter.

As described above, for a single-DCI based M-TRP PUSCH repetition scheme, both codebook based PUSCH transmission and non-codebook based PUSCH transmission may be supported.

In such a case, the maximum number of SRS resource sets may be enhanced to X (for example, X=2). A plurality of (for example, two) SRI fields corresponding to a plurality of (for example, two) SRS resource sets being included in a certain DCI format (for example, DCI format 0_1/0_2) used for scheduling of a PUSCH may be supported. Each SRI field may indicate an SRI of each TRP.

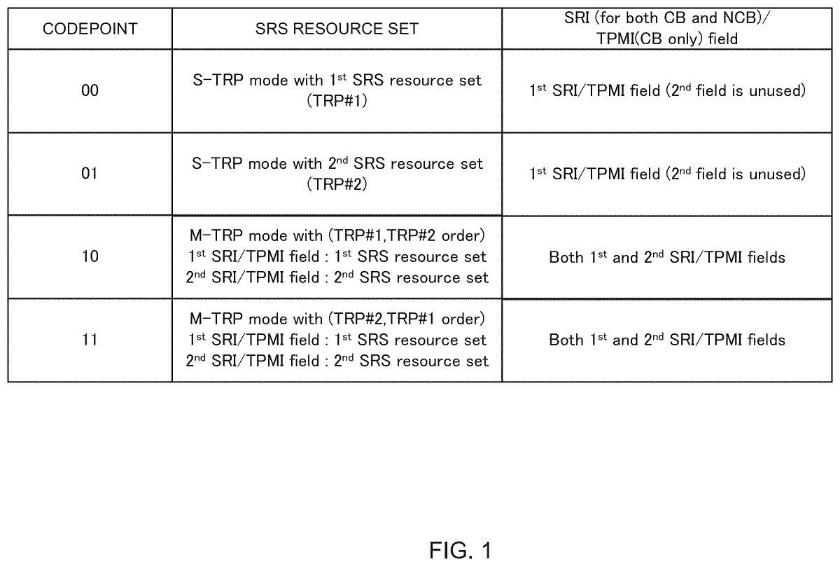

Dynamic switching (or switch) between a multi-TRP operation and a single-TRP operation may be supported. In this case, a field for indicating dynamic switch (for example, a new field) in downlink control information may be supported (refer to FIG. 1). FIG. 1 illustrates a case of indicating switching between a single-TRP mode and a multi-TRP mode by using 2-bit field. It is apparent that the number of bits and an indication content corresponding to each codepoint are not limited to this. The new field may be an SRS resource set indicator field.

One or more SRS resource sets (for example, a first SRS resource set and a second SRS resource set) used for a multi-TRP PUSCH scheduled by a certain DCI format may be defined by an entry of a higher layer parameter. The higher layer parameter may be a higher layer parameter related to an SRS resource set (for example, srs-ResourceSetToAddModList/srs-ResourceSetToAddModListDCI-0-2 included in SRS-config).

Presence of a field for dynamic switching (for example, a new field, an SRS resource set indicator field) included in the DCI may be determined separately for a plurality of DCI formats (for example, DCI format 0_1 and DCI format 0_2). For example, depending on whether a plurality of (for example, two) SRS resource sets are configured for each DCI format, presence/absence of a new field in each DCI format may be determined.

The same number of SRS resources may be supported in a plurality of (for example, two) SRS resource sets. For example, for codebook based multi-TRP PUSCH repetition, the numbers of SRS ports indicated by two SRIs may be the same.

Two SRIs, two TPMIs, and two power control parameter sets may be indicated. The two SRIs/TPMIs/power control parameter sets may be applied to K PUSCH repetitions (K consecutive slots for repetition type A) by using cyclic mapping or sequential mapping.

Each codepoint in the SRS resource set indicator field is associated with an SRS resource set and an SRI/TPMI field. Here, the SRI field is used for both CB and NCB, and the TPMI field is used only for CB. A codepoint “00” in the SRS resource set indicator field is associated with a single-TRP mode using a first SRS resource set (TRP 1) and a first SRI/TPMI field (second SRI/TPM field is not used). A codepoint “01” in the SRS resource set indicator field is associated with a single-TRP mode using a second SRS resource set (TRP 2) and the first SRI/TPMI field (second SRI/TPMI field is not used). A codepoint “10” in the SRS resource set indicator field is associated with a multi-TRP mode (in the order of TRP 1 and TRP 2) and both of the first and second SRI/TPMI fields. Here, the first SRI/TPMI field corresponds to the first SRS resource set, and the second SRI/TPMI field corresponds to the second SRS resource set. A codepoint “11” in the SRS resource set indicator field is associated with a multi-TRP mode (in the order of TRP 2 and TRP 1) and both of the first and second SRI/TPMI fields. Here, the first SRI/TPMI field corresponds to the first SRS resource set, and the second SRI/TPMI field corresponds to the second SRS resource set.

When DCI format 0_1 or DCI format 0_2 indicates the codepoint “10” for the SRS resource set indicator, association of the first and second SRS resource sets with K consecutive slots may follow associations 1-1 to 1-3 below.

### {Association 1-1}

In a case where K=2, the first and second SRS resource sets are applied to the first and second slots of two consecutive slots, respectively.

### {Association 1-2}

In a case where K>2 and cyclic mapping (cyclicMapping) in a PUSCH configuration (PUSCH-Config) is enabled, the first and second SRS resource sets are applied to the first and second slots of the K consecutive slots, respectively, and the same SRS resource set mapping pattern continues in the remaining slots of the K consecutive slots.

### {Association 1-3}

In a case where K>2 and sequential mapping (sequentialMapping) in a PUSCH configuration (PUSCH-Config) is enabled, the first SRS resource set is applied to the first and second slots of the K consecutive slots while the second SRS resource set is applied to the third and fourth slots of the K consecutive slots, and the same SRS resource set mapping pattern continues in the remaining slots of the K consecutive slots.

In other cases, when DCI format 0_1 or DCI format 0_2 indicates the codepoint “11” for the SRS resource set indicator, association of the first and second SRS resource sets with K consecutive slots may follow associations 2-1 to 2-3 below.

### {Association 2-1}

In a case where K=2, the second and first SRS resource sets are applied to the first and second slots of two consecutive slots, respectively.

### {Association 2-2}

In a case where K>2 and cyclic mapping (cyclicMapping) in a PUSCH configuration (PUSCH-Config) is enabled, the second and first SRS resource sets are applied to the first and second slots of the K consecutive slots, respectively, and the same SRS resource set mapping pattern continues in the remaining slots of the K consecutive slots.

### {Association 2-3}

In a case where K>2 and sequential mapping (sequentialMapping) in a PUSCH configuration (PUSCH-Config) is enabled, the second SRS resource set is applied to the first and second slots of the K consecutive slots while the first SRS resource set is applied to the third and fourth slots of the K consecutive slots, and the same SRS resource set mapping pattern continues in the remaining slots of the K consecutive slots.

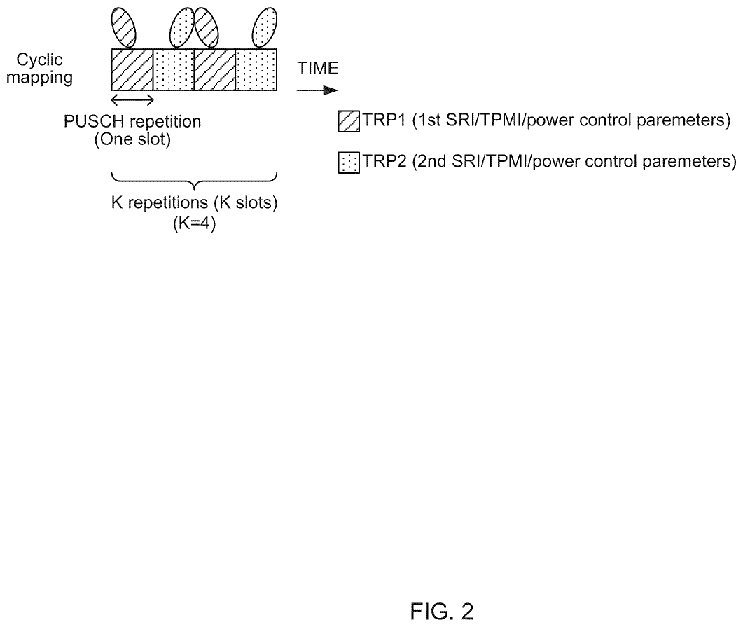

FIG. 2 illustrates an example of Rel-17 multi-TRP PUSCH repetition using repetition type A. This example uses cyclic mapping using the order of TRP 1 and TRP 2. In other words, the codepoint 10 is indicated for the SRS resource set indicator field. PUSCH repetition is transmitted over consecutive slots #1 to #4. first SRI/TPMI/power control parameters are applied to slots #1 and #3, and second SRI/TPMI/power control parameters are applied to slots #2 and #4.

### (Coverage Enhancement)

In Rel-17 coverage enhancement, enhancements 1 to 3 below are studied for a PUSCH.

### {Enhancement 1}

Transport block processing over multiple slots (TBoMS). One TB is processed and transmitted over a plurality of slots (N slots). N may be configured in each row of a time domain resource allocation (TDRA) table or may be configured outside the TDRA table.

### {Enhancement 2}

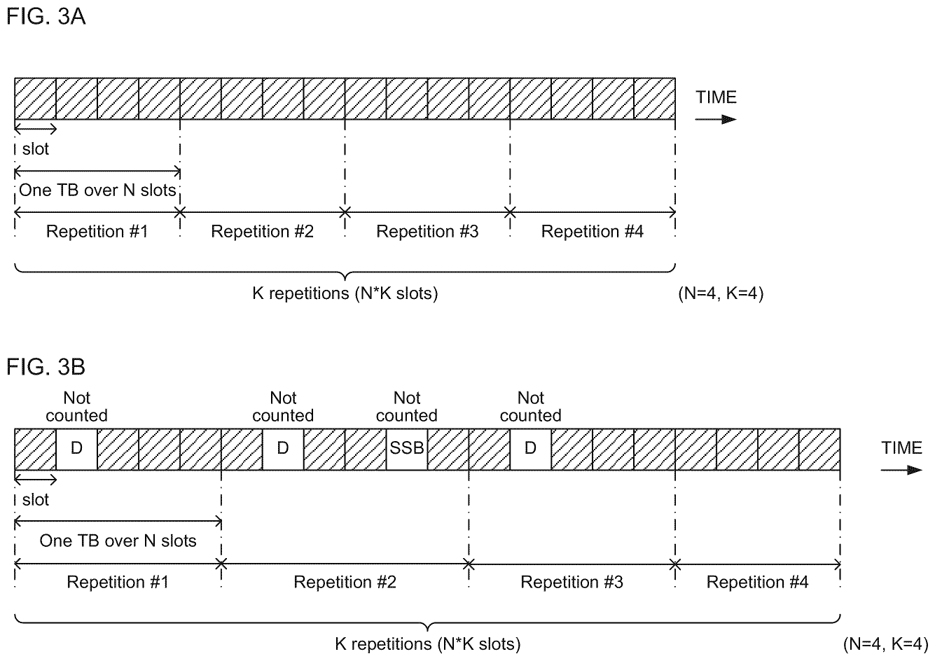

Together with the TBoMS, PUSCH repetition type A (K repetitions) may be configured. Each repetition is TBoMS using N slots. PUSCH transmission using TBoMS and repetition type A are in (N*K) slots in total. In the example in FIG. 3A, K is four (K=4) and N is four (N=4), one TB is transmitted over four slots, and repetition transmission is performed over 16 slots in total.

### {Enhancement 3}

An available slot(s) is based on at least one of a TDD UL-DL common configuration (tdd-UL-DL-ConfigurationCommon), a TDD UL-DL dedicated configuration (tdd-UL-DL-ConfigurationDedicated), and SSB positions in burst (ssb-PositionsinBurst). The UE may determine (N*K) slots for PUSCH transmission using TBoMS and repetition type A, based on at least one of tdd-UL-DL-ConfigurationCommon, tdd-UL-DL-ConfigurationDedicated, and ssb-PositionsinBurst. When at least one symbol in a certain slot overlaps a DL symbol indicated by tdd-UL-DL-ConfigurationCommon or tdd-UL-DL-ConfigurationDedicated or overlaps a symbol of an SS/PBCH block with an index provided by ssb-PositionsinBurst, the slot is not counted (not available) as the number of (N*K) slots. In the example in FIG. 3B, K is four (K=4), and N is four (N=4). In each repetition, a TB is transmitted over four slots except for the slot including a DL symbol indicated by tdd-UL-DL-ConfigurationCommon or tdd-UL-DL-ConfigurationDedicated or a symbol of an SS/PBCH block with an index provided by ssb-PositionsinBurst (slot “D” and slot “SSB” in FIG. 3B).

By using multi-TRP, study about whether and how TBoMS and determination of an available slot(s) are supported has not advanced yet. Unless these are appropriately defined, communication throughput, communication quality, and the like may degrade.

Thus, the inventors of the present invention came up with a method of TBoMS using multi-TRP and determination of an available slot(s).

Embodiments according to the present disclosure will be described in detail with reference to the drawings as follows. Note that the embodiments (for example, cases) below may each be employed individually, or at least two of the embodiments may be applied in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, time domain resource allocation and time domain resource assignment may be interchangeably interpreted.

### (Radio Communication Method)

In each embodiment, N may denote the number of slots of TBoMS (for example, numberOfSlotsTBoMS). In each embodiment, K may denote the number of repetitions (for example, numberOfRepetition).

In each embodiment, TBoMS (N>1) may be configured/indicated by one means among cases 1-1 to 1-4 below.
{Case 1-1} N>1 is configured in a row of a TDRA table, and the row is indicated by PUSCH scheduling DCI.
{Case 1-2} N>1 is configured in any of rows of the TDRA table configured by RRC (IE).
{Case 1-3} N>1 is provided by a higher layer configuration parameter for type 1 configured grant (CG) PUSCH (similarly to repK).
{Case 1-4} N>1 is configured in some of rows of the TDRA table configured by RRC (IE), and N>1 is indicated for type 1 CG PUSCH by RRC configuration.

In each embodiment, no repetition (K=1) may be configured/indicated by one means among cases 2-1 to 2-4 below.
{Case 2-1} K=1 is configured in a row of the TDRA table, and the row is indicated by PUSCH scheduling DCI.
{Case 2-2} No K is present. Or K=1 is configured in any of rows of the TDRA table configured by RRC (IE).
{Case 2-3} K=1 is provided by the number of repetitions (for example, other than the TDRA table, repK).
{Case 1-4} K=1 is configured in any of some of rows of the TDRA table configured by RRC (IE), and K=1 is indicated for type 1 CG PUSCH by RRC configuration.

In each embodiment, repetition (K>1) may be configured/indicated by one means among cases 3-1 to 3-4 below.
{Case 3-1} K>1 is configured in a row of the TDRA table, and the row is indicated by PUSCH scheduling DCI.
{Case 3-2} K>1 is configured in any of rows of the TDRA table configured by RRC (IE).
{Case 3-3} K>1 is provided by the number of repetitions (for example, repK).
{Case 3-4} K>1 is configured in some of rows of the TDRA table configured by RRC (IE), and K>1 is indicated for type 1 CG PUSCH by RRC configuration.

In each embodiment, a multi-TRP PUSCH may be configured/indicated by one means among cases 4-1 to 4-4 below.
{Case 4-1} A dynamic single-TRP/multi-TRP switch field (for example, an SRS resource set indicator field in Rel. 17 or another field in a future release) in PUSCH scheduling DCI indicates multi-TRP (for example, a codepoint in the SRS resource set indicator field in Rel. 17 is 10 or 11).
{Case 4-2} Two TCI/SRI/TPMI fields are configured by RRC (IE).
{Case 4-3} Two TCIs/SRIs/TPMIs are indicated by one TCI/SRI/TPMI field in PUSCH scheduling DCI.
{Case 4-4} Two SRS resource sets for CB/NCB are configured by RRC (IE).

In each embodiment, first/second TCI/SRI/TPMI/power control parameters may indicate any one of parameters 1 to 3 below.

### {Parameter 1}

TCI/SRI/TPMI/power control parameters associated with the first/second TCI/SRI/TPMI field.

### {Parameter 2}

TCI/SRI/TPMI/power control parameters associated with a first/second TCI/SRI/TPMI indicated by one TCI/SRI/TPMI field.

### {Parameter 3}

TCI/SRI/TPMI/power control parameters associated with a first/second SRS resource set (SRS resource set with a lower ID/higher ID).

In each embodiment, the power control parameter may include P0/alpha/closed loop index.

In each embodiment, by interpreting PUSCH scheduling DCI as a CG configuration, the embodiment may be applied to a CG PUSCH.

In each embodiment, a parameter, a parameter for transmission to one TRP, TCI/SRI/TPMI/power control parameters, an SRS resource set, and an SRS resource set associated with a parameter may be interchangeably interpreted. Similarly, the i^{th} parameter, a parameter for transmission to the i^{th} TRP, the i^{th} TCI/SRI/TPMI/power control parameters, the i^{th} SRS resource set, and an SRS resource set associated with the i^{th} TCI/SRI/TPMI/power control parameters may be interchangeably interpreted. Here, i may be an integer equal to or greater than one, for example, one or two.

In each embodiment, mapping, a pattern, a mapping pattern, an SRS resource set mapping pattern, and application may be interchangeably interpreted.

In each embodiment, a TDRA table and a TDRA list may be interchangeably interpreted. In each embodiment, a row of a TDRA table and an element/entry of a TDRA list may be interchangeably interpreted.

In each embodiment, a transport block, a code block, and UL data may be interchangeably interpreted.

### First Embodiment

This embodiment relates to a multi-TRP PUSCH and TBoMS without repetition (N>1, K=1).

The UE may follow any one of options 1-1 and 1-2 and variations of 1-2 below.

### <<Option 1-1>>

For PUSCH transmission, the UE does not assume to be configured/indicated with TBoMS without repetition (N>1, K=1) and configured/indicated with a multi-TRP PUSCH. In this case, N slots of the TBoMS may be transmitted to the same TRP. In other words, the same TCI/SRI/TPMI/power control parameters may be applied to the N slots of the TBoMS.

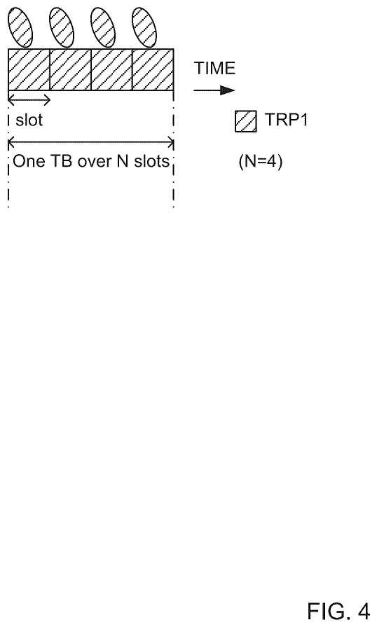

FIG. 4 illustrates an example of option 1-1. In the example, N is four (N=4). One TB is transmitted to one TRP over 4 slots.

### <<Option 1-2>>

For PUSCH transmission, the UE may assume to be configured/indicated with TBoMS without repetition (N>1, K=1) and configured/indicated with a multi-TRP PUSCH. In this case, N slots of the TBoMS may be transmitted to a plurality of TRPs. In other words, different TCI/SRI/TPMI/power control parameters may be applied to the N slots of the TBoMS.

By using any one of patterns 1 to 8 below, a plurality of (two) TCI/SRI/TPMI/power control parameters may be applied to a plurality of (N) slots.

### {Pattern 1}

Cyclic mapping using the order from TRP 1 to TRP 2: First TCI/SRI/TPMI/power control parameters are applied to the first slot, second TCI/SRI/TPMI/power control parameters are applied to the second slot, and the same pattern continues in the remaining slots of the N slots.

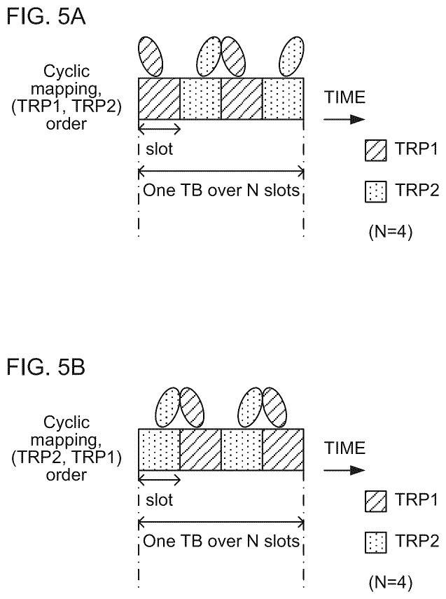

FIG. 5A illustrates an example of pattern 1 of option 1-2. In this example, N is four (N=4), and one TB is transmitted over four slots. Among the four slots, transmission in the first and third slots use the first TCI/SRI/TPMI/power control parameters (transmitted to TRP 1). Among the four slots, transmission in the second and fourth slots use the second TCI/SRI/TPMI/power control parameters (transmitted to TRP 2).

### {Pattern 2}

Cyclic mapping using the order from TRP 2 to TRP 1: The second TCI/SRI/TPMI/power control parameters are applied to the first slot, the first TCI/SRI/TPMI/power control parameters are applied to the second slot, and the same pattern continues in the remaining slots of the N slots.

FIG. 5B illustrates an example of pattern 2 of option 1-2. In this example, N is four (N=4), and one TB is transmitted over four slots. Among the four slots, transmission in the first and third slots use the second TCI/SRI/TPMI/power control parameters (transmitted to TRP 2). Among the four slots, transmission in the second and fourth slots use the first TCI/SRI/TPMI/power control parameters (transmitted to TRP 1).

### {Pattern 3}

Sequential mapping using the order from TRP 1 to TRP 2: The first TCI/SRI/TPMI/power control parameters are applied to the first and second slots, the second TCI/SRI/TPMI/power control parameters are applied to the third and fourth slots, and the same pattern continues in the remaining slots of the N slots.

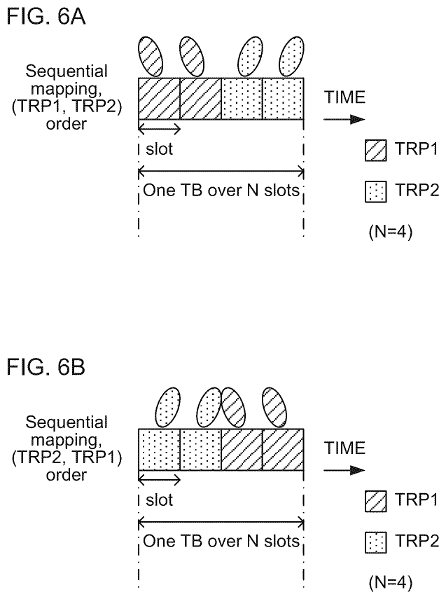

FIG. 6A illustrates an example of pattern 3 of option 1-2. In this example, N is four (N=4), and one TB is transmitted over four slots. Among the four slots, transmission in the first and second slots use the first TCI/SRI/TPMI/power control parameters (transmitted to TRP 1). Among the four slots, transmission in the third and fourth slots use the second TCI/SRI/TPMI/power control parameters (transmitted to TRP 2).

### {Pattern 4}

Sequential mapping using the order from TRP 2 to TRP 1: The second TCI/SRI/TPMI/power control parameters are applied to the first and second slots, the first TCI/SRI/TPMI/power control parameters are applied to the third and fourth slots, and the same pattern continues in the remaining slots of the N slots.

FIG. 6B illustrates an example of pattern 4 of option 1-2. In this example, N is four (N=4), and one TB is transmitted over four slots. Among the four slots, transmission in the first and second slots use the second TCI/SRI/TPMI/power control parameters (transmitted to TRP 2). Among the four slots, transmission in the third and fourth slots use the first TCI/SRI/TPMI/power control parameters (transmitted to TRP 1).

### {Pattern 5}

Half-half mapping using the order from TRP 1 to TRP 2: The first TCI/SRI/TPMI/power control parameters are applied to the first floor (N/2) slots or the first ceil (N/2) slots, and the second TCI/SRI/TPMI/power control parameters are applied to the remaining slots of the N slots.

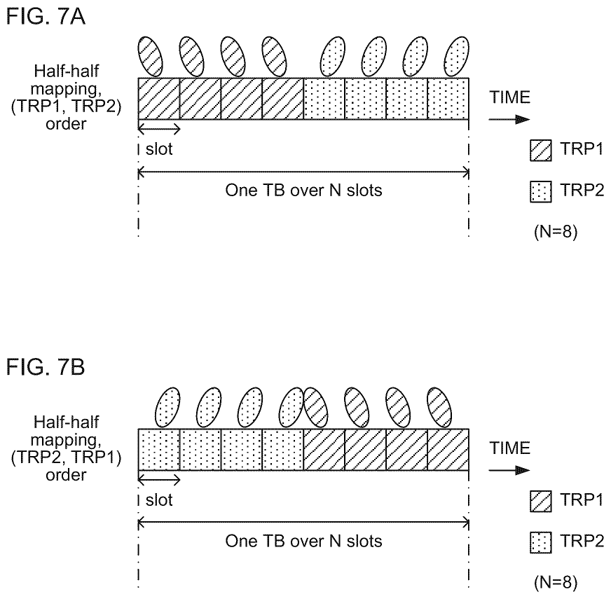

FIG. 7A illustrates an example of pattern 5 of option 1-2. In this example, N is eight (N=8), and one TB is transmitted over eight slots. Among the eight slots, transmission in the first to fourth slots use the first TCI/SRI/TPMI/power control parameters (transmitted to TRP 1). Among the four slots, transmission in the fifth to eighth slots use the second TCI/SRI/TPMI/power control parameters (transmitted to TRP 2).

### {Pattern 6}

Half-half mapping using the order from TRP 2 to TRP 1: The second TCI/SRI/TPMI/power control parameters are applied to the first floor (N/2) slots or the first cell (N/2) slots, and the first TCI/SRI/TPMI/power control parameters are applied to the remaining slots of the N slots.

FIG. 7B illustrates an example of pattern 6 of option 1-2. In this example, N is eight (N=8), and one TB is transmitted over eight slots. Among the eight slots, transmission in the first to fourth slots use the second TCI/SRI/TPMI/power control parameters (transmitted to TRP 2). Among the four slots, transmission in the fifth to eighth slots use the first TCI/SRI/TPMI/power control parameters (transmitted to TRP 1).

### {Pattern 7}

Configurable pattern using the order from TRP 1 to TRP 2: The first TCI/SRI/TPMI/power control parameters are applied to the first X slots, the second TCI/SRI/TPMI/power control parameters are applied to the second X slots, and the same pattern continues in the remaining slots of the N slots.

### {Pattern 8}

Configurable pattern using the order from TRP 2 to TRP 1: The second TCI/SRI/TPMI/power control parameters are applied to the first X slots, the first TCI/SRI/TPMI/power control parameters are applied to the second X slots, and the same pattern continues in the remaining slots of the N slots.

In pattern 1/2 (first mapping) of option 1-2, two different parameters from the first and second TCI/SRI/TPMI/power control parameters/SRS resource sets may be applied to an odd-numbered ((2i+1)^{th}) slot and an even-numbered (2i^{th}) slot of the N slots. Here, i may be an integer equal to or greater than zero.

In pattern 3/4 (second mapping) of option 1-2, two different parameters from the first and second TCI/SRI/TPMI/power control parameters/SRS resource sets may be applied to the (4i+1)^{th} and (4i+2)^{th} slots of the N slots and the (4i+2)^{th} and (4i+3)^{th} slots of the N slots. Here, i may be an integer equal to or greater than zero.

In pattern 5/6 (third mapping) of option 1-2, two different parameters from the first and second TCI/SRI/TPMI/power control parameters/SRS resource sets may be applied to a slot(s) in the first half and a slot(s) in the second half of the N slots.

In pattern 7/8 (fourth mapping) of option 1-2, two different parameters from the first and second TCI/SRI/TPMI/power control parameters/SRS resource sets may be applied to the (4Xj+1)^{th} to (4Xj+X)^{th} slots of the N slots and the (4Xj+X+1)^{th} to (4Xj+2X)^{th} slots of the N slots. Here, j may be an integer equal to or greater than zero.

Only some (for example, patterns 1 to 4) of patterns 1 to 8 may be supported.

A plurality of patters of patterns 1 to 8 may be switched by RRC signaling, a MAC CE, DCI, or a combination of RRC signaling/MAC CE/DCI (information indicating one mapping). For example, cyclic mapping or sequential mapping may be switched by RRC signaling. The order of TRPs may be switched by the DCI field in PUSCH scheduling DCI.

### <<Variations of Option 1-2>>

For PUSCH transmission, even when the UE is configured/indicated with TBoMS without repetition (N>1, K=1) and is configured/indicated with a multi-TRP PUSCH, one of TCI/SRI/TPMI/power control parameters of one of defaults (default TRP) may be applied. In this case, N slots of the TBoMS may be transmitted to the same TRP. In other words, the same TCI/SRI/TPMI/power control parameters may be applied to the N slots of the TBoMS. Which one of the first and second TCI/SRI/TPMI/power control parameters is applied as a default may be defined.

According to this embodiment, a UE can appropriately perform a multi-TRP PUSCH and TBoMS without repetition.

### Second Embodiment

This embodiment relates to a multi-TRP PUSCH and TBoMS with repetition (N>1, K>1).

The UE may follow either of options 2-1 and 2-2 below.

### <<Option 2-1>>

For PUSCH transmission, the UE does not assume to be configured/indicated with TBoMS with repetition (N>1, K>1) and configured/indicated with a multi-TRP PUSCH.

### <<Option 2-2>>

For PUSCH transmission, the UE assumes to be configured/indicated with TBoMS with repetition (N>1, K>1) and configured/indicated with a multi-TRP PUSCH. The UE may follow any one of options 2-2-1 to 2-2-3 below.

### {Option 2-2-1}

K repetitions may be transmitted to a plurality of TRPs. In other words, different TCI/SRI/TPMI/power control parameters may be applied to the K repetitions. In each repetition, N slots of the TBoMS may be transmitted to the same TRP. In other words, the same TCI/SRI/TPMI/power control parameters may be applied to the N slots of the TBoMS. Each repetition may use N slots. By using any one of patterns 1 to 8 below, a plurality of (two) TCI/SRI/TPMI/power control parameters may be applied to a plurality of (K) repetitions.

### {Pattern 1}

Cyclic mapping using the order from TRP 1 to TRP 2: The first TCI/SRI/TPMI/power control parameters are applied to the first repetition (first N slots), the second TCI/SRI/TPMI/power control parameters are applied to the second repetition (second N slots), and the same pattern continues in the remaining repetitions (remaining slots) of the K repetitions (N*K slots).

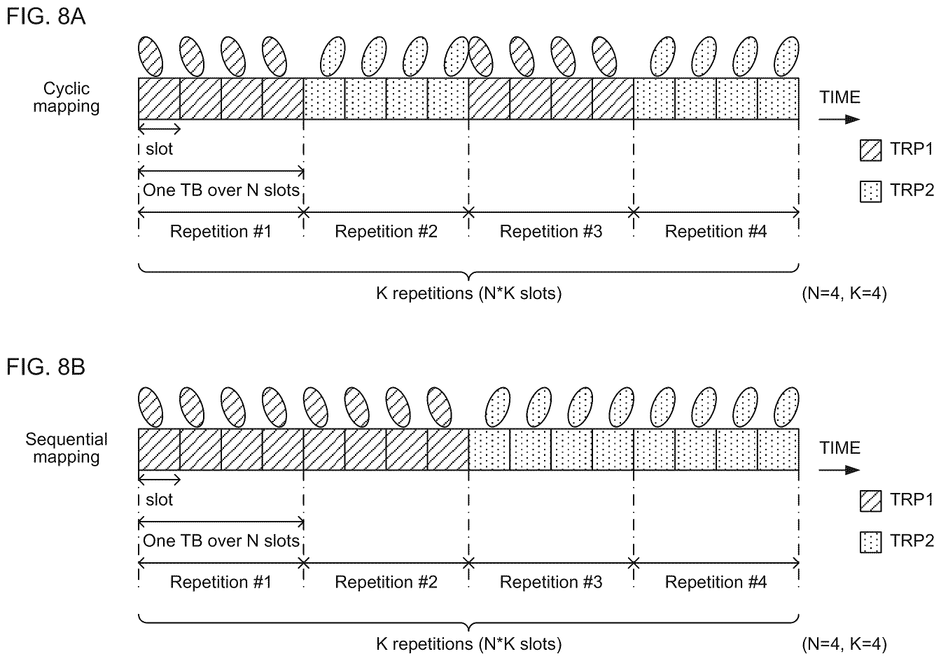

FIG. 8A illustrates an example of pattern 1 of option 2-2-1. In this example, N is four (N=4) and K is four (K=4), one repetition of one TB is transmitted over four slots, and four repetitions are transmitted over 16 slots. Among the four repetitions, transmissions of the first and third repetitions use the first TCI/SRI/TPMI/power control parameters (transmitted to TRP 1). Among the four repetitions, transmissions of the second and fourth repetitions use the second TCI/SRI/TPMI/power control parameters (transmitted to TRP 2).

### {Pattern 2}

Cyclic mapping using the order from TRP 2 to TRP 1: The second TCI/SRI/TPMI/power control parameters are applied to the first repetition (first N slots), the first TCI/SRI/TPMI/power control parameters are applied to the second repetition (second N slots), and the same pattern continues in the remaining repetitions (remaining slots) of the K repetitions (N*K slots).

FIG. 8B illustrates an example of pattern 2 of option 2-2-1. In this example, N is four (N=4) and K is four (K=4), one repetition of one TB is transmitted over four slots, and four repetitions are transmitted over 16 slots. Among the four repetitions, transmissions of the first and third repetitions use the second TCI/SRI/TPMI/power control parameters (transmitted to TRP 2). Among the four repetitions, transmissions of the second and fourth repetitions use the first TCI/SRI/TPMI/power control parameters (transmitted to TRP 1).

### {Pattern 3}

Sequential mapping using the order from TRP 1 to TRP 2: The first TCI/SRI/TPMI/power control parameters are applied to the first and second repetitions (first and second N slots), the second TCI/SRI/TPMI/power control parameters are applied to the third and fourth repetitions (third and fourth N slots), and the same pattern continues in the remaining repetitions (remaining slots) of the K repetitions (N*K slots).

### {Pattern 4}

Sequential mapping using the order from TRP 2 to TRP 1: The second TCI/SRI/TPMI/power control parameters are applied to the first and second repetitions (first and second N slots), the first TCI/SRI/TPMI/power control parameters are applied to the third and fourth repetitions (third and fourth N slots), and the same pattern continues in the remaining repetitions (remaining slots) of the K repetitions (N*K slots).

### {Pattern 5}

Half-half mapping using the order from TRP 1 to TRP 2: The first TCI/SRI/TPMI/power control parameters are applied to the first floor (K/2) repetitions (first floor (N*K/2) slots) or the first ceil (K/2) repetitions (first ceil (N*K/2) slots), and the second TCI/SRI/TPMI/power control parameters are applied to the remaining repetitions (remaining slots) of the K repetitions ((N*K) slots).

### {Pattern 6}

Half-half mapping using the order from TRP 1 to TRP 2: The second TCI/SRI/TPMI/power control parameters are applied to the first floor (K/2) repetitions (first floor (N*K/2) slots) or the first ceil (K/2) repetitions (first ceil (N*K/2) slots), and the first TCI/SRI/TPMI/power control parameters are applied to the remaining repetitions (remaining slots) of the K repetitions ((N*K) slots).

### {Pattern 7}

Configurable pattern using the order from TRP 1 to TRP 2: The first TCI/SRI/TPMI/power control parameters are applied to the first X repetitions (first N*X slots), the second TCI/SRI/TPMI/power control parameters are applied to the second X repetitions (second N*X slots), and the same pattern continues in the remaining repetitions (remaining slots) of the K repetitions (N*K slots).

### {Pattern 8}

Configurable pattern using the order from TRP 2 to TRP 1: The second TCI/SRI/TPMI/power control parameters are applied to the first X repetitions (first N*X slots), the first TCI/SRI/TPMI/power control parameters are applied to the second X repetitions (second N*X slots), and the same pattern continues in the remaining repetitions (remaining slots) of the K repetitions (N*K slots).

In pattern 1/2 (first mapping) of option 2-2-1, two different parameters from the first and second TCI/SRI/TPMI/power control parameters/SRS resource sets may be applied to an odd-numbered ((2i+1)^{th}) repetition and an even-numbered (2i^{th}) repetition of the K repetitions. Here, i may be an integer equal to or greater than zero.

In pattern 3/4 (second mapping) of option 2-2-1, two different parameters from the first and second TCI/SRI/TPMI/power control parameters/SRS resource sets may be applied to the (4i+1)^{th} and (4i+2)^{th} repetitions of the K repetitions and the (4i+2)^{th} and (4i+3)^{th} repetitions of the K repetitions. Here, i may be an integer equal to or greater than zero.

In pattern 5/6 (third mapping) of option 2-2-1, two different parameters from the first and second TCI/SRI/TPMI/power control parameters/SRS resource sets may be applied to a repetition(s) in the first half and a repetition(s) in the second half of the K repetitions.

In pattern 7/8 (fourth mapping) of option 2-2-1, two different parameters from the first and second TCI/SRI/TPMI/power control parameters/SRS resource sets may be applied to the (4Xj+1)^{th} to (4Xj+X)^{th} repetitions of the K repetitions and the (4Xj+X+1)^{th} to (4Xj+2X)^{th} repetitions of the K repetitions. Here, j may be an integer equal to or greater than zero.

Only some (for example, patterns 1 to 4) of patterns 1 to 8 may be supported.

A plurality of patters of patterns 1 to 8 may be switched by RRC signaling, a MAC CE, DCI, or a combination of RRC signaling/MAC CE/DCI (information indicating one mapping). For example, cyclic mapping or sequential mapping may be switched by RRC signaling. The order of TRPs may be switched by the DCI field in PUSCH scheduling DCI.

Option 2-2-1 may follow at least one of operations A to D below.

### {Operation A}

For PUSCH repetition type A in a case where K>1, the UE may follow operation a below in an SRS resource set list (srs-ResourceSetToAddModList or srs-ResourceSetToAddModListDCI-0-2) with a higher layer parameter usage being set to ‘codebook’ or ‘noncodebook’ among SRS resource sets (SRS-ResourceSet).

{{Operation a}}

If the PUSCH is scheduled by DCI format 0_1 or 0_2, the UE may follow operations a1 and a2 below.

### Operation a1

If available slot counting (AvailableSlotCounting) is enabled, the same symbol mapping may be applied over (N*K) slots determined for the PUSCH transmission, and the PUSCH may be limited to a single transmission layer. The UE may apply the same symbol mapping in each slot, repeat a TB over the (N*K) slots determined for the PUSCH transmission, and determine association of the first and second SRS resource sets in srs-ResourceSetToAddModList or srs-ResourceSetToAddModListDCI-0-2 with each slot as associations a1 to a4 below.

### Association a1

If DCI format 0_1 or 0_2 indicates the codepoint “00” for the SRS resource set indicator, the first SRS resource set may be associated with all the (N*K) slots determined for the PUSCH transmission.

### Association a2

If DCI format 0_1 or 0_2 indicates the codepoint “01” for the SRS resource set indicator, the second SRS resource set may be associated with all the (N*K) slots determined for the PUSCH transmission.

### Association a3

When DCI format 0_1 or DCI format 0_2 indicates the codepoint “10” for the SRS resource set indicator, association of the first and second SRS resource sets with (N*K) slots determined for the PUSCH transmission may be determined as follows.
In a case where K=2, the first and second SRS resource sets are applied to the first N slots (from the first slot to the N^{th} slot) and the second N slots (from the (N+1)^{th} slot to the 2N^{th} slot) determined for the PUSCH transmission, respectively.
In a case where K>2 and cyclic mapping (cyclicMapping) in a PUSCH configuration (PUSCH-Config) is enabled, the first and second SRS resource sets are applied to the first N slots (from the first slot to the N^{th} slot) and the second N slots (from the (N+1)^{th} slot to the 2N^{th} slot), respectively, among the (N*K) slots determined for the PUSCH transmission, and the same SRS resource mapping pattern continues in the remaining slots of the (N*K) slots determined for the PUSCH transmission.
In a case where K>2 and sequential mapping (sequentialMapping) in a PUSCH configuration (PUSCH-Config) is enabled, the first SRS resource set is applied to the first N slots (from the first slot to the N^{th} slot) and the second N slots (from the (N+1)^{th} slot to the 20th slot) among the (N*K) slots determined for the PUSCH transmission, the second SRS resource set is applied to the third N slots (from the (2N+1)^{th} slot to the 3N^{th} slot) and the fourth N slots (from the (3N+1)^{th} slot to the 4N^{th} slot) among the (N*K) slots determined for the PUSCH transmission, and the same SRS resource set mapping pattern continues in the remaining slots of the (N*K) slots determined for the PUSCH transmission.

### Association a4

In other cases, when DCI format 0_1 or DCI format 0_2 indicates the codepoint “11” for the SRS resource set indicator, association of the first and second SRS resource sets with (N*K) slots determined for the PUSCH transmission may be as follows.
In a case where K=2, the second and first SRS resource sets are applied to the first N slots (from the first slot to the N^{th} slot) and the second N slots (from the (N+1)^{th} slot to the 2N^{th} slot) determined for the PUSCH transmission, respectively.
In a case where K>2 and cyclic mapping (cyclicMapping) in a PUSCH configuration (PUSCH-Config) is enabled, the second and first SRS resource sets are applied to the first N slots (from the first slot to the N^{th} slot) and the second N slots (from the (N+1)^{th} slot to the 2N^{th} slot), respectively, among the (N*K) slots determined for the PUSCH transmission, and the same SRS resource mapping pattern continues in the remaining slots of the (N*K) slots determined for the PUSCH transmission.
In a case where K>2 and sequential mapping (sequentialMapping) in a PUSCH configuration (PUSCH-Config) is enabled, the second SRS resource set is applied to the first N slots (from the first slot to the N^{th} slot) and the second N slots (from the (N+1)^{th} slot to the 2N^{th} slot) among the (N*K) slots determined for the PUSCH transmission, the first SRS resource set is applied to the third N slots (from the (2N+1)^{th} slot to the 3N^{th} slot) and the fourth N slots (from the (3N+1)^{th} slot to the 4N^{th} slot) among the (N*K) slots determined for the PUSCH transmission, and the same SRS resource set mapping pattern continues in the remaining slots of the (N*K) slots determined for the PUSCH transmission.

### Operation a2

In other cases (if AvailableSlotCounting is not enabled), the same symbol mapping may be applied over (N*K) consecutive slots determined for the PUSCH transmission, and the PUSCH may be limited to a single transmission layer. The UE may apply the same symbol mapping in each slot and repeat a TB over the (N*K) consecutive slots determined for the PUSCH transmission.

### {Operation B}

For PUSCH repetition type A in a case where K>1, the UE may follow operation b below in an SRS resource set list (srs-ResourceSetToAddModList or srs-ResourceSetToAddModListDCI-0-2) with a higher layer parameter usage being set to ‘codebook’ or ‘noncodebook’ among SRS resource sets (SRS-ResourceSet) when two SRS resource sets are configured.

{{Operation b}}

If the PUSCH is scheduled by DCI format 0_1 or 0_2, the UE may follow operation a1 described above or operation b2 below.

### Operation b2

In other cases (if AvailableSlotCounting is not enabled), the same symbol mapping may be applied over (N*K) consecutive slots determined for the PUSCH transmission, and the PUSCH may be limited to a single transmission layer. The UE may apply the same symbol mapping in each slot, repeat a TB over the (N*K) consecutive slots determined for the PUSCH transmission, and determine association of the first and second SRS resource sets in srs-ResourceSetToAddModList or srs-ResourceSetToAddModListDCI-0-2 with each slot as associations b1 to b4 below.

### Association b1

If DCI format 0_1 or 0_2 indicates the codepoint “00” for the SRS resource set indicator, the first SRS resource set may be associated with all the (N*K) consecutive slots determined for the PUSCH transmission.

### Association b2

If DCI format 0_1 or 0_2 indicates the codepoint “01” for the SRS resource set indicator, the second SRS resource set may be associated with all the (N*K) consecutive slots determined for the PUSCH transmission.

### Association b3

When DCI format 0_1 or DCI format 0_2 indicates the codepoint “10” for the SRS resource set indicator, association of the first and second SRS resource sets with (N*K) consecutive slots determined for the PUSCH transmission may be determined as follows.
In a case where K=2, the first and second SRS resource sets are applied to the first N slots (from the first slot to the N^{th} slot) and the second N slots (from the (N+1)^{th} slot to the 2N^{th} slot) determined for the PUSCH transmission, respectively.
In a case where K>2 and cyclic mapping (cyclicMapping) in a PUSCH configuration (PUSCH-Config) is enabled, the first and second SRS resource sets are applied to the first N slots (from the first slot to the N^{th} slot) and the second N slots (from the (N+1)^{th} slot to the 2N^{th} slot), respectively, among the (N*K) consecutive slots determined for the PUSCH transmission, and the same SRS resource mapping pattern continues in the remaining slots of the (N*K) consecutive slots determined for the PUSCH transmission.
In a case where K>2 and sequential mapping (sequentialMapping) in a PUSCH configuration (PUSCH-Config) is enabled, the first SRS resource set is applied to the first N slots (from the first slot to the N^{th} slot) and the second N slots (from the (N+1)^{th} slot to the 2N^{th} slot) among the (N*K) consecutive slots determined for the PUSCH transmission, the second SRS resource set is applied to the third N slots (from the (2N+1)^{th} slot to the 3N^{th} slot) and the fourth N slots (from the (3N+1)^{th} slot to the 4N^{th} slot) among the (N*K) consecutive slots determined for the PUSCH transmission, and the same SRS resource set mapping pattern continues in the remaining slots of the (N*K) consecutive slots determined for the PUSCH transmission.

### Association b4

In other cases, when DCI format 0_1 or DCI format 0_2 indicates the codepoint “11” for the SRS resource set indicator, association of the first and second SRS resource sets with (N*K) consecutive slots determined for the PUSCH transmission may be as follows.
In a case where K=2, the second and first SRS resource sets are applied to the first N slots (from the first slot to the N^{th} slot) and the second N slots (from the (N+1)^{th} slot to the 2N^{th} slot) determined for the PUSCH transmission, respectively.
In a case where K>2 and cyclic mapping (cyclicMapping) in a PUSCH configuration (PUSCH-Config) is enabled, the second and first SRS resource sets are applied to the first N slots (from the first slot to the N^{th} slot) and the second N slots (from the (N+1)^{th} slot to the 2N^{th} slot), respectively, among the (N*K) consecutive slots determined for the PUSCH transmission, and the same SRS resource mapping pattern continues in the remaining slots of the (N*K) consecutive slots determined for the PUSCH transmission.
In a case where K>2 and sequential mapping (sequentialMapping) in a PUSCH configuration (PUSCH-Config) is enabled, the second SRS resource set is applied to the first N slots (from the first slot to the N^{th} slot) and the second N slots (from the (N+1)^{th} slot to the 2N^{th} slot) among the (N*K) consecutive slots determined for the PUSCH transmission, the first SRS resource set is applied to the third N slots (from the (2N+1)^{th} slot to the 3N^{th} slot) and the fourth N slots (from the (3N+1)^{th} slot to the 4N^{th} slot) among the (N*K) consecutive slots determined for the PUSCH transmission, and the same SRS resource set mapping pattern continues in the remaining slots of the (N*K) consecutive slots determined for the PUSCH transmission.

### {Operation C}

TB processing over a plurality of slots may follow operations c1 and c2 below when two SRS resource sets are configured in an SRS resource set list (srs-ResourceSetToAddModList or srs-ResourceSetToAddModListDCI-0-2) with a higher layer parameter usage being set to ‘codebook’ or ‘noncodebook’ among SRS resource sets (SRS-ResourceSet).

### Operation c1

For an unpaired spectrum, the same symbol mapping may be applied over (N*K) slots determined for the PUSCH transmission, and the PUSCH may be limited to a single transmission layer. The UE may apply the same symbol mapping in each slot, repeat a TB over the (N*K) slots determined for the PUSCH transmission, and determine association of the first and second SRS resource sets in srs-ResourceSetToAddModList or srs-ResourceSetToAddModListDCI-0-2 with each slot as associations a1 to a4 described above.

### Operation c2

For a paired spectrum or a supplementary uplink band, the same symbol mapping may be applied over (N*K) consecutive slots determined for the PUSCH transmission, and the PUSCH may be limited to a single transmission layer. The UE may apply the same symbol mapping in each slot and repeat a TB over the (N*K) consecutive slots determined for the PUSCH transmission.

### {Operation D}

TB processing over a plurality of slots may follow operation c1 described above and operation d2 below when two SRS resource sets are configured in an SRS resource set list (srs-ResourceSetToAddModList or srs-ResourceSetToAddModListDCI-0-2) with a higher layer parameter usage being set to ‘codebook’ or ‘noncodebook’ among SRS resource sets (SRS-ResourceSet)

### Operation d2

For a paired spectrum or a supplementary uplink band, the same symbol mapping may be applied over (N*K) consecutive slots determined for the PUSCH transmission, and the PUSCH may be limited to a single transmission layer. The UE may apply the same symbol mapping in each slot, repeat a TB over the (N*K) consecutive slots determined for the PUSCH transmission, and determine association of the first and second SRS resource sets in srs-ResourceSetToAddModList or srs-ResourceSetToAddModListDCI-0-2 with each slot as associations b1 to b4 described above.

### {Option 2-2-2}

N slots in each repetition may be transmitted to a plurality of TRPs. In other words, different TCI/SRI/TPMI/power control parameters may be applied to the N slots in each repetition. In each repetition, a plurality of (two) TCI/SRI/TPMI/power control parameters may be applied to N slots by using option 1-2.

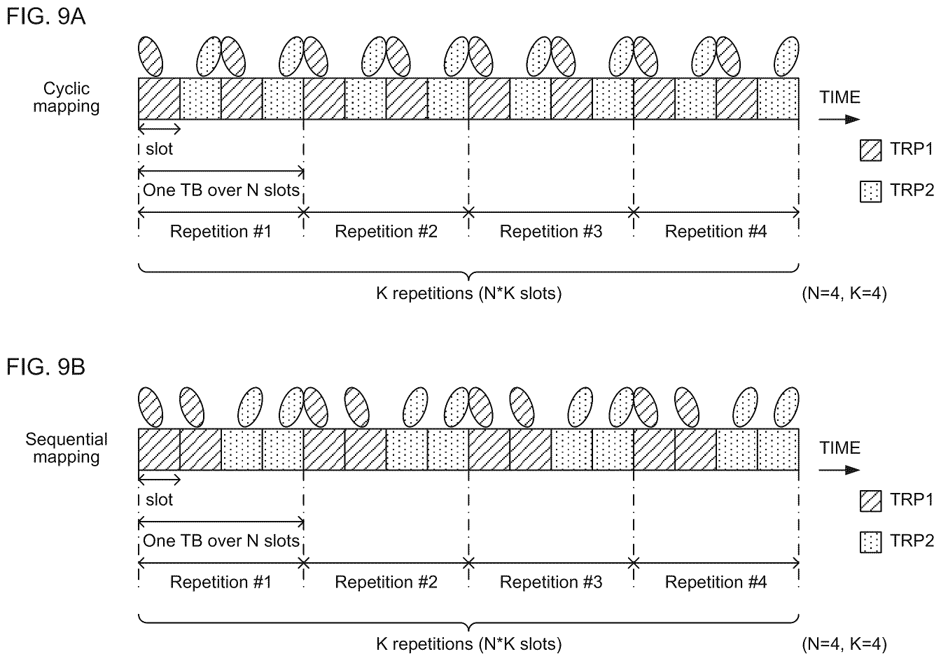

FIG. 9A illustrates an example of pattern 1 of option 2-2-2. In this example, N is four (N=4) and K is four (K=4), one repetition of one TB is transmitted over four slots, and four repetitions are transmitted over 16 slots. Among the four slots in each repetition, transmission in the first and third slots use the first TCI/SRI/TPMI/power control parameters (transmitted to TRP 1). Among the four slots in each repetition, transmission in the second and fourth slots use the second TCI/SRI/TPMI/power control parameters (transmitted to TRP 2).

FIG. 9B illustrates an example of pattern 3 of option 2-2-2. In this example, N is four (N=4) and K is four (K=4), one repetition of one TB is transmitted over four slots, and four repetitions are transmitted over 16 slots. Among the four slots in each repetition, transmission in the first and second slots use the first TCI/SRI/TPMI/power control parameters (transmitted to TRP 1). Among the four slots in each repetition, transmission in the third and fourth slots use the second TCI/SRI/TPMI/power control parameters (transmitted to TRP 2).

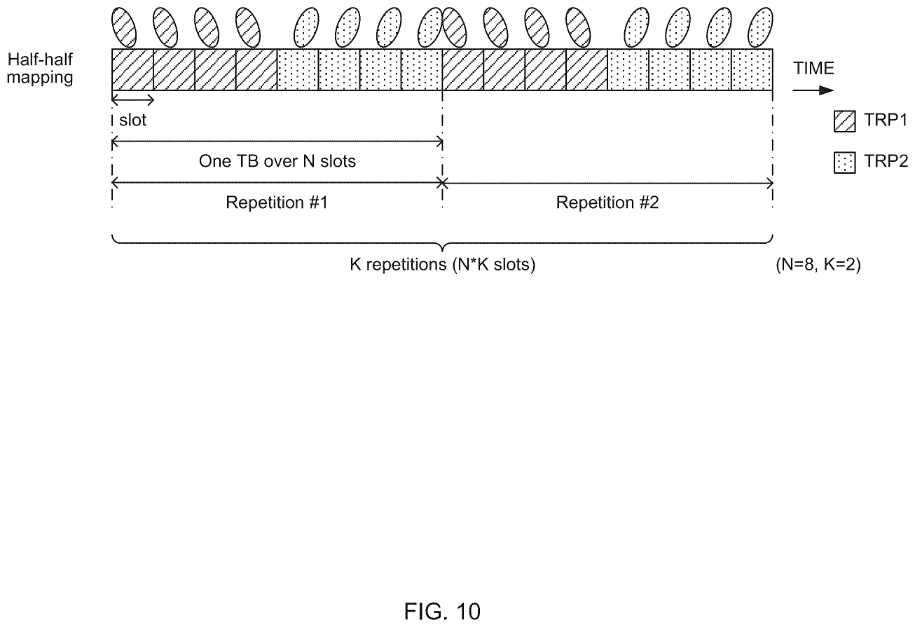

FIG. 10 illustrates an example of pattern 5 of option 2-2-2. In this example, N is eight (N=8) and K is two (K=2), one repetition of one TB is transmitted over eight slots, and two repetitions are transmitted over 16 slots. Among the eight slots in each repetition, transmission in the first to fourth slots use the first TCI/SRI/TPMI/power control parameters (transmitted to TRP 1). Among the four slots in each repetition, transmission in the fifth to eighth slots use the second TCI/SRI/TPMI/power control parameters (transmitted to TRP 2).

In pattern 1/2 (fifth mapping) of option 2-2-2, two different parameters from the first and second TCI/SRI/TPMI/power control parameters/SRS resource sets may be applied to an odd-numbered ((2i+1)^{th}) slot and an even-numbered (2i^{th}) slot of the N slots in each repetition. Here, i may be an integer equal to or greater than zero.

In pattern 3/4 (sixth mapping) of option 2-2-2, two different parameters from the first and second TCI/SRI/TPMI/power control parameters/SRS resource sets may be applied to the (4i+1)^{th} and (4i+2)^{th} slots of the N slots in each repetition and the (4i+2)^{th} and (4i+3)^{th} slots of the N slots in each repetition. Here, i may be an integer equal to or greater than zero.

In pattern 5/6 (seventh mapping) of option 2-2-2, two different parameters from the first and second TCI/SRI/TPMI/power control parameters/SRS resource sets may be applied to a slot in the first half and a slot in the second half of the N slots in each repetition.

In pattern 7/8 (eighth mapping) of option 2-2-2, two different parameters from the first and second TCI/SRI/TPMI/power control parameters/SRS resource sets may be applied to the (4Xj+1)^{th} to (4Xj+X)^{th} slots of the N slots in each repetition and the (4Xj+X+1)^{th} to (4Xj+2X)^{th} slots of the N slots in each repetition. Here, j may be an integer equal to or greater than zero.

### {Option 2-2-3}

(N*K) slots may be transmitted to a plurality of TRPs. In other words, different TCI/SRI/TPMI/power control parameters may be applied to the (N*K) slots. By using any one of patterns 1 to 8 below (similarly to option 1-2), a plurality of (two) TCI/SRI/TPMI/power control parameters may be applied to the (N*K) slots.

### {Pattern 1}

Cyclic mapping using the order from TRP 1 to TRP 2: The first TCI/SRI/TPMI/power control parameters are applied to the first slot, the second TCI/SRI/TPMI/power control parameters are applied to the second slot, and the same pattern continues in the remaining slots of the (N*K) slots.

### {Pattern 2}

Cyclic mapping using the order from TRP 2 to TRP 1: The second TCI/SRI/TPMI/power control parameters are applied to the first slot, the first TCI/SRI/TPMI/power control parameters are applied to the second slot, and the same pattern continues in the remaining slots of the (N*K) slots.

### {Pattern 3}

Sequential mapping using the order from TRP 1 to TRP 2: The first TCI/SRI/TPMI/power control parameters are applied to the first and second slots, the second TCI/SRI/TPMI/power control parameters are applied to the third and fourth slots, and the same pattern continues in the remaining slots of the (N*K) slots.

### {Pattern 4}

Sequential mapping using the order from TRP 2 to TRP 1: The second TCI/SRI/TPMI/power control parameters are applied to the first and second slots, the first TCI/SRI/TPMI/power control parameters are applied to the third and fourth slots, and the same pattern continues in the remaining slots of the (N*K) slots.

### {Pattern 5}

Half-half mapping using the order from TRP 1 to TRP 2: The first TCI/SRI/TPMI/power control parameters are applied to the first floor (N/2) slots or the first ceil (N/2) slots, and the second TCI/SRI/TPMI/power control parameters are applied to the remaining slots of the (N*K) slots.

### {Pattern 6}

Half-half mapping using the order from TRP 2 to TRP 1: The second TCI/SRI/TPMI/power control parameters are applied to the first floor (N/2) slots or the first cell (N/2) slots, and the first TCI/SRI/TPMI/power control parameters are applied to the remaining slots of the (N*K) slots.

### {Pattern 7}

Configurable pattern using the order from TRP 1 to TRP 2: The first TCI/SRI/TPMI/power control parameters are applied to the first X slots, the second TCI/SRI/TPMI/power control parameters are applied to the second X slots, and the same pattern continues in the remaining slots of the (N*K) slots.

### {Pattern 8}

Configurable pattern using the order from TRP 2 to TRP 1: The second TCI/SRI/TPMI/power control parameters are applied to the first X slots, the first TCI/SRI/TPMI/power control parameters are applied to the second X slots, and the same pattern continues in the remaining slots of the (N*K) slots.

In pattern 1/2 (ninth mapping) of option 2-2-3, two different parameters from the first and second TCI/SRI/TPMI/power control parameters/SRS resource sets may be applied to an odd-numbered ((2i+1)^{th}) slot and an even-numbered (2i^{th}) slot of the (N×K) slots. Here, i may be an integer equal to or greater than zero.

In pattern 3/4 (tenth mapping) of option 2-2-3, two different parameters from the first and second TCI/SRI/TPMI/power control parameters/SRS resource sets may be applied to the (4i+1)^{th} and (4i+2)^{th} slots of the (N×K) slots and the (4i+2)^{th} and (4i+3)^{th} slots of the (N×K) slots. Here, i may be an integer equal to or greater than zero.

In pattern 5/6 (eleventh mapping) of option 2-2-3, two different parameters from the first and second TCI/SRI/TPMI/power control parameters/SRS resource sets may be applied to a slot in the first half and a slot in the second half of the (N×K) slots.

In pattern 7/8 (twelfth mapping) of option 2-2-3, two different parameters from the first and second TCI/SRI/TPMI/power control parameters/SRS resource sets may be applied to the (4Xj+1)^{th} to (4Xj+X)^{th} slots of the (N×K) slots and the (4Xj+X+1)^{th} to (4Xj+2X)^{th} slots of the (N×K) slots. Here, j may be an integer equal to or greater than zero.

Only some (for example, patterns 1 to 4) of patterns 1 to 8 may be supported.

A plurality of patters of patterns 1 to 8 may be switched by RRC signaling, a MAC CE, DCI, or a combination of RRC signaling/MAC CE/DCI (information indicating one mapping). For example, cyclic mapping or sequential mapping may be switched by RRC signaling. The order of TRPs may be switched by the DCI field in PUSCH scheduling DCI.

### {Difference Between Options 2-2-2 and 2-2-3}

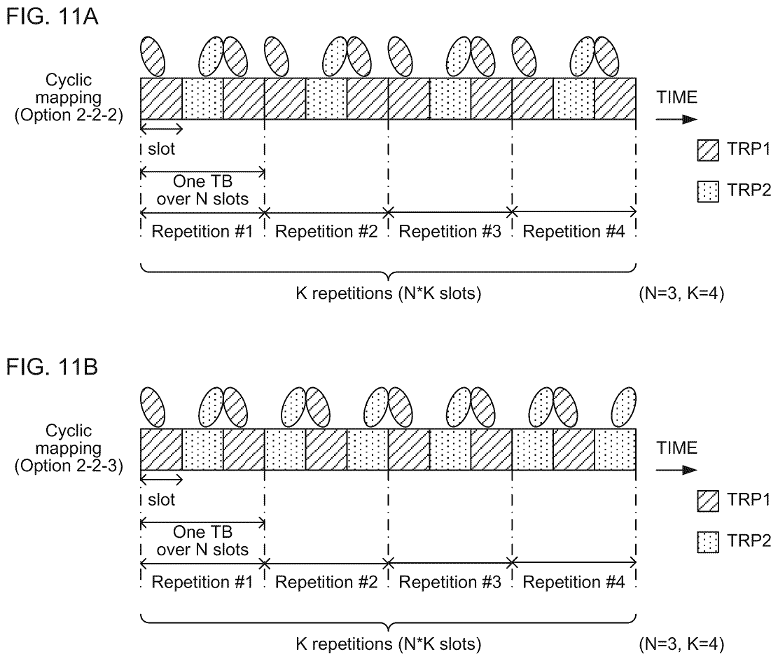

FIG. 11A illustrates an example of pattern 1 (cyclic mapping) of option 2-2-2. In this example, N is three (N=3) and K is four (K=4), one repetition of one TB is transmitted over three slots, and four repetitions are transmitted over 12 slots. Among the three slots in each repetition, transmission in the first and third slots use the first TCI/SRI/TPMI/power control parameters (transmitted to TRP 1). Among the three slots in each repetition, transmission in the second uses the second TCI/SRI/TPMI/power control parameters (transmitted to TRP 2).

FIG. 11B illustrates an example of pattern 1 (cyclic mapping) of option 2-2-3. In this example, N is three (N=3) and K is four (K=4), one repetition of one TB is transmitted over three slots, and four repetitions are transmitted over 12 slots. Among the twelve slots, transmission in the first, third, and . . . slots (odd-numbered slots) use the first TCI/SRI/TPMI/power control parameters (transmitted to TRP 1). Among the twelve slots, transmission in the second, fourth, . . . slots (even-numbered slots) use the second TCI/SRI/TPMI/power control parameters (transmitted to TRP 2).

According to this embodiment, a UE can appropriately perform a multi-TRP PUSCH and TBoMS with repetition.

### Third Embodiment

This embodiment relates to a multi-TRP PUSCH and available slot determination.

When available slot determination (for example, AvailableSlotCounting) is enabled, a UE may follow at least one of available slot determination methods 1 and 2 below.

### {Available Slot Determination Method 1}

When at least one symbol indicated by an indexed row of a TDRA table in a certain slot overlaps a DL symbol indicated by tdd-UL-DL-ConfigurationCommon or tdd-UL-DL-ConfigurationDedicated or overlaps a symbol of an SS/PBCH block with an index provided by ssb-PositionsinBurst, the slot is not counted as (N*K) slots for TBoMS/PUSCH repetition type A scheduled by DCI format 0_1 or 0_2 (not available as the (N*K) slots).

### {Available Slot Determination Method 2}

In the first/second embodiment, TCI/SRI/TPMI/power control parameters are mapped to (N*K) slots determined to be available for the PUSCH transmission. The (N*K) slots may be slots obtained by excluding U slots determined to be unavailable among (N*K+U) consecutive slots. U may be an integer equal to or greater than zero.

According to this embodiment, a UE can appropriately determine slots available for a multi-TRP PUSCH.

### Other Embodiments

### <<UE Capability Information/Higher Layer Parameter>>

A higher layer parameter (RRC IE)/UE capability corresponding to a function (characteristics, feature) in each of the above embodiments may be defined. The higher layer parameter may indicate whether to enable the function. The UE capability may indicate whether a UE supports the function.

The UE configured with the higher layer parameter corresponding to the function may perform the function. The “UE not configured with the higher layer parameter corresponding to the function does not perform the function (for example, follows Rel. 15/16)” may be defined.

The UE that has reported/transmitted UE capability indicating support of the function may perform the function. The “UE that has not reported the UE capability indicating support of the function does not perform the function (for example, follows Rel. 15/16)” may be defined.

When the UE reports/transmits the UE capability indicating support of the function and a higher layer parameter corresponding to the function is configured, the UE may perform the function. “When the UE does not report/transmit the UE capability indicating support of the function or when the UE is not configured with the higher layer parameter corresponding to the function, the UE does not perform the function (for example, follows Rel. 15/16)” may be defined.

Which embodiment/option/choice/function of the plurality of embodiments above is to be used may be configured by a higher layer parameter, reported by a UE as UE capability, defined in a specification, or determined by reported UE capability and configuration of a higher layer parameter.

The UE capability may indicate whether the UE supports at least one of the following functions.
Multi-TRP PUSCH for TBoMS without repetition (N>1, K=1). For example, option 1-2.
Multi-TRP PUSCH for TBoMS with repetition (N>1, K>1). For example, option 2-2.

The UE capability may indicate at least one of the following values.
Maximum number of repetitions of a multi-TRP PUSCH (maximum number of K). Maximum number of repetitions of a multi-TRP PUSCH based on dynamic grant (maximum number of K). Maximum number of repetitions of a multi-TRP PUSCH based on configured grant (maximum number of K).
Maximum number of slots of TBoMS (maximum number of N). Maximum number of slots for TBoMS based on dynamic grant (maximum number of N). Maximum number of slots for TBoMS based on configured grant (maximum number of N).

According to the UE capability/higher layer parameter above, a UE can implement the above-described function while maintaining compatibility with an existing specification.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

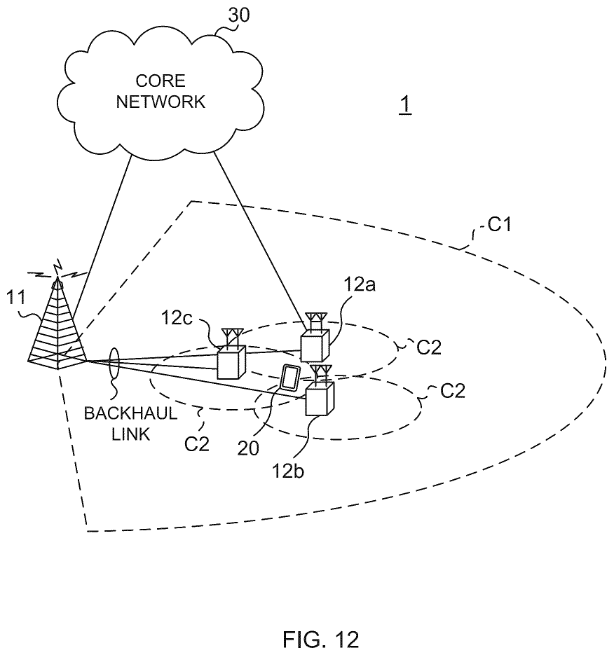

FIG. 12 is a diagram to illustrate an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect illustrated in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and DMRS for PBCH) may be referred to as an SS/PBCH block, an SS Block (SSB), or the like. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS).

Note that DMRS may be referred to as a “user terminal specific reference signal (UE-specific Reference Signal).”

### (Base Station)

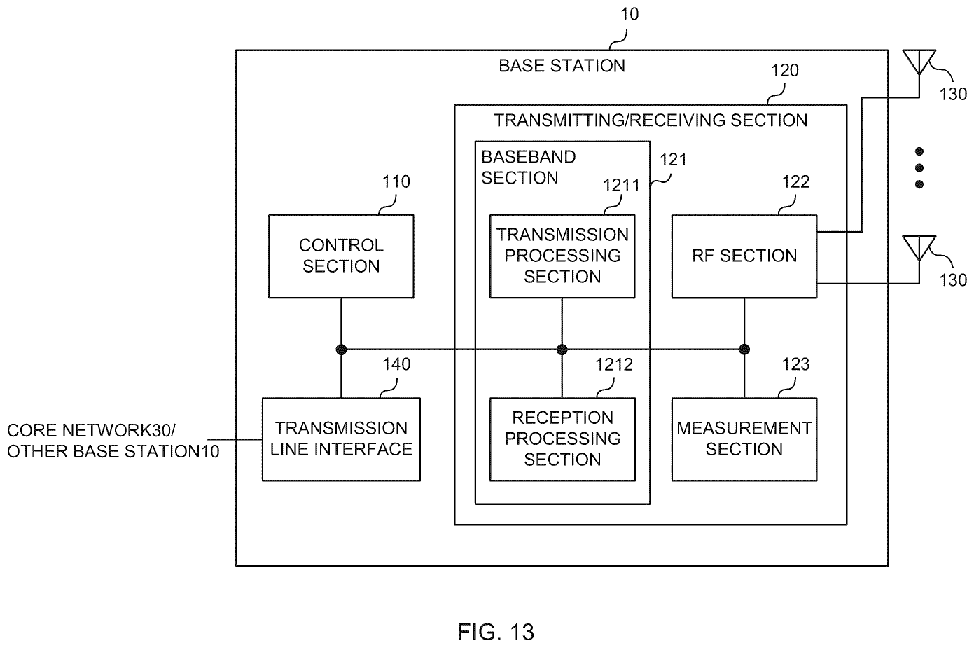

FIG. 13 is a diagram to illustrate an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily illustrates functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211 and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit a first parameter for transmission to a first transmission/reception point (TRP) and a second parameter for transmission to a second TRP. The control section 110 may control reception of one transport block over N slots, and N parameters may be applied to the N slots, respectively. The N parameters may include at least one of the first parameter and the second parameter, and N may be an integer equal to or greater than two.

The transmitting/receiving section 120 may transmit a first parameter for transmission to a first transmission/reception point (TRP) and a second parameter for transmission to a second TRP. The control section 110 may control reception of K repetitions of reception of one transport block over N slots. (N×K) parameters may be applied to (N×K) slots in which the K repetitions are transmitted, respectively. The (N×K) parameters may include the first parameter and the second parameter, N may be an integer equal to or greater than two, and K may be an integer equal to or greater than two.

### (User Terminal)

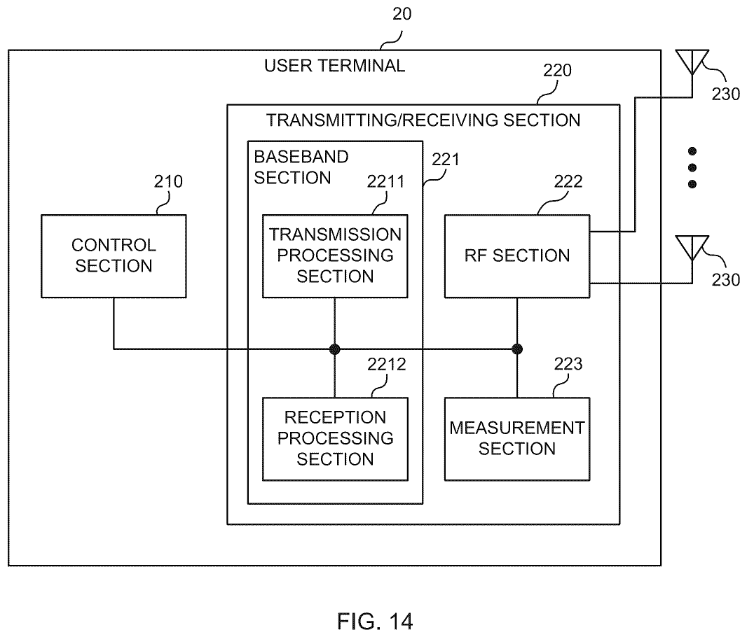

FIG. 14 is a diagram to illustrate an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily illustrates functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211 and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate a bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230,

The transmitting/receiving section 220 may receive a first parameter for transmission to a first transmission/reception point (TRP) and a second parameter for transmission to a second TRP. The control section 210 may control transmission of one transport block over N slots and apply N parameters to the N respective slots. The N parameters may include at least one of the first parameter and the second parameter, and N may be an integer equal to or greater than two.

The control section 210 may perform one mapping of first mapping for applying two different parameters of the first parameter and the second parameter to an odd-numbered slot and an even-numbered slot of the N slots, second mapping for applying two different parameters of the first parameter and the second parameter to (4i+1)^{th} and (4i+2)^{th} slots of the N slots and (4i+2)^{th} and (4i+3)^{th} slots of the N slots, third mapping for applying two different parameters of the first parameter and the second parameter to a slot in the first half and a slot in the second half of the N slots, and fourth mapping for applying two different parameters of the first parameter and the second parameter to (4Xj+1)^{th} to (4Xj+X)^{th} slots of the N slots and (4Xj+X+1)^{th} to (4Xj+2X)^{th} slots of the N slots. i may be an integer equal to or greater than zero, j may be an integer equal to or greater than zero, and X may be an integer equal to or greater than one.

The transmitting/receiving section 220 may receive information indicating one of the first mapping, the second mapping, the third mapping, and the fourth mapping.

The N parameters may be N first parameters or N second parameters.

The transmitting/receiving section 220 may receive a first parameter for transmission to a first transmission/reception point (TRP) and a second parameter for transmission to a second TRP. The control section 210 may control transmission of K repetitions of transmission of one transport block over N slots and apply (N×K) parameters to the (N×K) slots in which the K repetitions are transmitted, respectively. The (N×K) parameters may include the first parameter and the second parameter, N may be an integer equal to or greater than two, and K may be an integer equal to or greater than two.

The control section 210 may perform one mapping of first mapping for applying two different parameters of the first parameter and the second parameter to an odd-numbered repetition and an even-numbered repetition of the K repetitions, second mapping for applying two different parameters of the first parameter and the second parameter to (4i+1)^{th} and (4i+2)^{th} repetitions of the K repetitions and (4i+2)^{th} and (4i+3)^{th} repetitions of the K repetitions, third mapping for applying two different parameters of the first parameter and the second parameter to a repetition in the first half and a repetition in the second half of the K repetitions, fourth mapping for applying two different parameters of the first parameter and the second parameter to (4Xj+1)^{th} to (4Xj+X)^{th} repetitions of the K repetitions and (4Xj+X+1)^{th} to (4Xj+2X)^{th} repetitions of the K repetitions, fifth mapping for applying two different parameters of the first parameter and the second parameter to an odd-numbered slot and an even-numbered slot of the N slots in each repetition, sixth mapping for applying two different parameters of the first parameter and the second parameter to (4i+1)^{th} and (4i+2)^{th} slots of the N slots in each repetition and (4i+2)^{th} and (4i+3)^{th} slots of the N slots in each repetition, seventh mapping for applying two different parameters of the first parameter and the second parameter to a slot in the first half and a slot in the second half of the N slots in each repetition, eighth mapping for applying two different parameters of the first parameter and the second parameter to (4Xj+1)^{th} to (4Xj+X)^{th} slots of the N slots in each repetition and (4Xj+X+1)^{th} to (4Xj+2X)^{th} slots of the N slots in each repetition, ninth mapping for applying two different parameters of the first parameter and the second parameter to an odd-numbered slot and an even-numbered slot of the (N×K) slots, tenth mapping for applying two different parameters of the first parameter and the second parameter to (4i+1)^{th} and (4i+2)^{th} slots of the (N×K) slots and (4i+2)^{th} and (4i+3)^{th} slots of the (N×K) slots, eleventh mapping for applying two different parameters of the first parameter and the second parameter to a slot in the first half and a slot in the second half of the (N×K) slots, and twelfth mapping for applying two different parameters of the first parameter and the second parameter to (4Xj+1)^{th} to (4Xj+X)^{th} slots of the (N×K) slots and (4Xj+X+1)^{th} to (4Xj+2X)^{th} slots of the (N×K) slots. i may be an integer equal to or greater than zero, j may be an integer equal to or greater than zero, and X may be an integer equal to or greater than one.

The transmitting/receiving section 220 may receive information indicating the one mapping.

The (N×K) slots may be slots obtained by excluding U slots determined to be unavailable among (N×K+U) consecutive slots, and U may be an integer equal to or greater than zero.

### (Hardware Structure)

Note that the block diagrams that have been used to describe the above embodiments illustrate blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

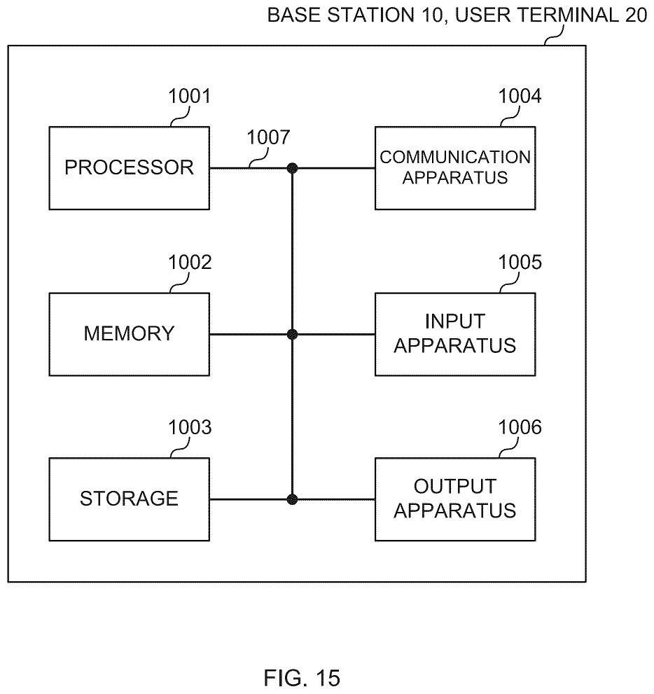

For example, a base station, a user terminal, and so on according to one embodiment of the present disclosure may function as a computer that executes the processes of the radio communication method of the present disclosure. FIG. 15 is a diagram to illustrate an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses illustrated in the drawings, or may be configured not to include part of apparatuses.

For example, although only one processor 1001 is illustrated, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure,

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP,

The BWP may include a UL BWP (BWP for UL) and a DL BWP (BWP for DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. Since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

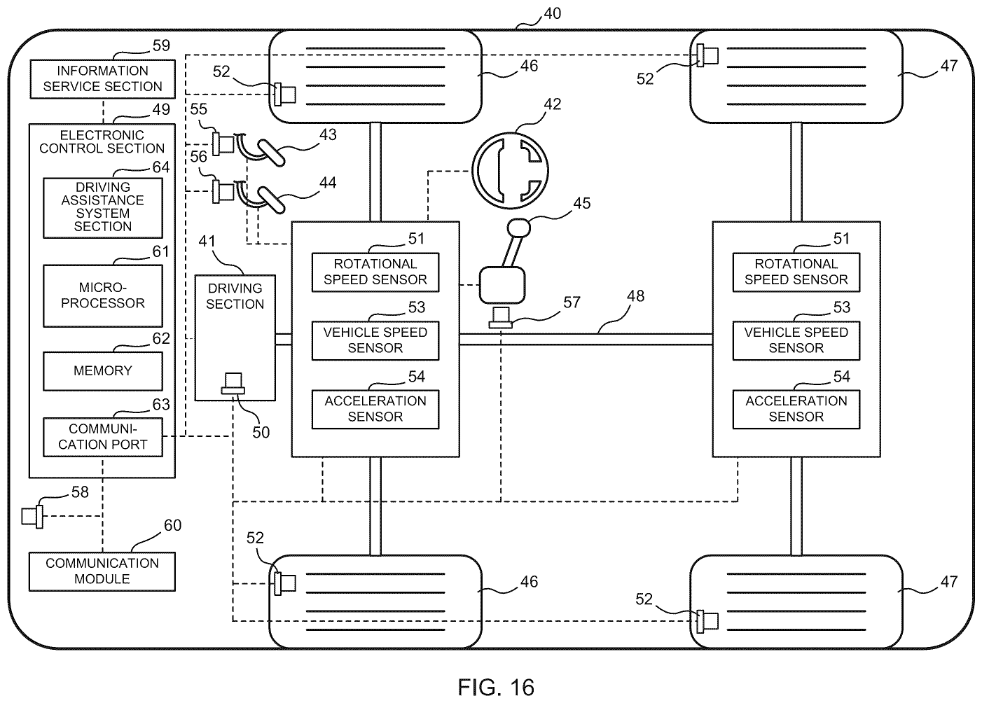

FIG. 16 is a diagram to illustrate an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU),

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various information such as drive information, traffic information, and entertainment information, such as a car navigation system, an audio system, a speaker, a display, a television, and a radio, and one or more ECUs that control these devices. The information service section 59 provides various information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LIDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU), an inertial navigation apparatus (inertial navigation system (INS)), and the like), an artificial intelligence (AI) chip, and an AI processor, and one or more ECUs that control these devices. The driving assistance system section 64 transmits and receives various information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various information (traffic information, signal information, inter-vehicle distance information, and the like) transmitted from the external apparatus, and displays the various information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various information received from the external apparatus in the memory 62 that can be used by the microprocessor 61, Based on the information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark), CDMA 2000, Ultra Mobile Broadband (UMB), IEEE 802.11 (Wi-Fi (registered trademark)), IEEE 802.16 (WIMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives a first parameter for transmission to a first transmission/reception point (TRP) and a second parameter for transmission to a second TRP; and
a control section that controls transmission of one transport block over N slots and applies N parameters to the N respective slots, the N parameters including at least one of the first parameter and the second parameter, N being an integer equal to or greater than two.

2. The terminal according to claim 1, wherein
the control section performs one mapping of first mapping for applying two different parameters of the first parameter and the second parameter to an odd-numbered slot and an even-numbered slot of the N slots, second mapping for applying two different parameters of the first parameter and the second parameter to (4i+1)^{th} and (4)+2)^{th} slots of the N slots and (4i+2)^{th} and (4i+3)^{th} slots of the N slots, third mapping for applying two different parameters of the first parameter and the second parameter to a slot in a first half and a slot in a second half of the N slots, and fourth mapping for applying two different parameters of the first parameter and the second parameter to (4Xj+1)^{th} to (4Xj+X)^{th} slots of the N slots and (4Xj+X+1)^{th} to (4Xj+2X)^{th} slots of the N slots, i being an integer equal to or greater than zero, j being an integer equal to or greater than zero, X being an integer equal to or greater than one.

3. The terminal according to claim 2, wherein
the receiving section receives information indicating one of the first mapping, the second mapping, the third mapping, and the fourth mapping.

4. The terminal according to claim 1, wherein
the N parameters are N first parameters or N second parameters.

5. A radio communication method for a terminal, the radio communication method comprising:
receiving a first parameter for transmission to a first transmission/reception point (TRP) and a second parameter for transmission to a second TRP; and
controlling transmission of one transport block over N slots and applying N parameters to the N respective slots, the N parameters including at least one of the first parameter and the second parameter, N being an integer equal to or greater than two.

6. A base station comprising:
a transmitting section that transmits a first parameter for transmission to a first transmission/reception point (TRP) and a second parameter for transmission to a second TRP; and
a control section that controls reception of one transport block over N slots, N parameters being applied to the N respective slots, the N parameters including at least one of the first parameter and the second parameter, N being an integer equal to or greater than two.
